(19) United States
(12) Patent Application Publication
(10) Pub. No.: US 2012/0282518 A1
(43) Pub. Date: Nov. 8, 2012

(54) CELL CASE

(75) Inventor: Oh Jeong Ahn, Cheonan-si (KR)

(73) Assignee: NIFCO KOREA INC., Cheonan-si (KR)

(21) Appl. No.: 13/505,384

(22) PCT Filed: Nov. 2, 2010
(86) PCT No.: PCT/KR2010/007645

§ 371 Date: Jul. 16, 2012

(30) Foreign Application Priority Data
Nov. 6, 2009 (KR) 10-2009-0106990

(51) Int. Cl. H01M 2/02

(52) U.S. Cl. 429/163

(57) ABSTRACT

A cell case has a plurality of front slide connection parts each having an engaged groove in a lower part thereof and an engaging piece protrudingly formed in an upper part thereof; and a plurality of rear slide connection parts each having an engaged groove in a lower part thereof, an engaging protruding piece protrudingly formed in an upper part thereof, and an insertion hole formed in a lower surface thereof into which the engaging protruding piece is inserted. The cell case is connected or disconnected through forward-backward sliding movement.

### TECHNICAL FIELD

The present invention relates to a battery case, and in particular, a battery case that can be vertically stacked with ease according to a sliding assembling method.

### BACKGROUND ART

In particular, the present invention relates to a battery case that enables batteries to be vertically stacked.

FIG. 1 is a front perspective view of a conventional battery case, and FIG. 2 is a rear perspective view of the conventional battery cases in a stacked state.

The conventional battery case that enables batteries to be vertically stacked has, as shown in FIG. 1 and FIG. 2, a battery storage part 21 in the center of an interior thereof, engaged grooves (not shown) on both sides of the rear of a lower surface, engaging protrusions 22 on both sides of the rear of an upper surface, which correspond to the engaged grooves, and a fastening hole 23 in the center of the front of the upper surface.

A plurality of the conventional battery cases 20 can be continuously stacked in a vertical direction by inserting the engaging protrusions 22 on the both sides of the rear of the upper surface into the respective engaged grooves on the both sides of the rear of the lower surface. After many cases are continuously stacked, a fastening guide plate is assembled to three fastening grooves 24 provided on the rear surface and finally the fastening guide plates are fastened to the respective battery case with a plurality of screws. For this reason, a part is often disengaged during assembling. Further, assembling takes a long time as well as high assembling costs due to poor assembling property.

Moreover, in assembling the front part of the conventional battery case 20, one long bolt is penetrated into the fastening hole 23 provided in the center of the front of the upper surface, and then fastened with a nut. As a result, corners on the right and left sides of the front are disadvantageously extended. When a faulty battery case is replaced, battery cases other than the faulty battery case must be removed, making replacing work so complicated.

### SUMMARY OF THE INVENTION

### Problem to be Solved by the Invention

The present invention is made in consideration of the above-mentioned defects of the conventional battery case, and its object is to provide a battery case that can be vertically stacked more easily and solidly.

### Means for Solving the Problems

To attain the above-mentioned object, a battery case according to the present invention is provided with a plurality of slide connection parts in each of the front and the rear thereof, such that the battery case can be connected or disconnected through forward-backward sliding movement.

That is, a battery case of the present invention includes a plurality of front slide connection parts each including an engaged groove in a lower part thereof and an engaging piece protrudingly formed in an upper part thereof, and a plurality of rear slide connection parts each including an engaged groove in the lower part thereof, an engaging protruding piece protrudingly formed in the upper part and an insertion hole formed in the lower surface thereof, into which the engaging protruding piece can be inserted, such that the battery case can be connected or disconnected through forward-backward sliding movement.

In the battery case of the present invention, an upper locking protrusion having an inclined rear end is protrudingly formed in the rear of an upper surface, and a lower locking protrusion corresponding to the upper locking protrusion and having an inclined front end is formed to depress in the rear of a lower surface. Thus, the upper locking protrusion of the lower battery case and the lower locking protrusion of the upper battery case are engaged with each other, thereby preventing the upper battery case correctly assembled onto the lower battery case from moving in the forward-backward direction.

In the battery case of the present invention, a protruding piece having a scrivet connection hole is formed in the rear of an upper surface, a protruding piece insertion space is formed in the rear of a lower surface, and a scrivet connection hole is formed in the rear of the protruding piece insertion space. Thus, the upper battery case correctly assembled onto the lower battery case can be prevented from moving in the forward-backward direction by the scrivet.

### Effect of the Invention

According to the present invention, since the upper battery case can be easily assembled by placing the upper battery case on the lower battery case and moving the upper battery case forward, assembling property can be largely improved, and assembling time and assembling costs can be largely saved. Further, a decrease in the number of components necessary for assembling greatly contributes to cost reduction. In the case of replacing a faulty battery, only the faulty battery case can be removed, simplifying the replacing work.

### BRIEF DESCRIPTION OF THE DRAWINGS

FIG. 1 is a front perspective view of a conventional battery case.

FIG. 2 is a rear perspective view of the conventional battery cases in a stacked state.

FIG. 3 is a perspective view showing a stacked state in accordance with first embodiment of the present invention.

FIG. 4 is a perspective cutaway view of a main part in the stacked state in accordance with the first embodiment of the present invention.

FIG. 5(a) and FIG. 5(b) are perspective cutaway views of a front slide connecting part before and after assembling in accordance with the first embodiment of the present invention.

FIG. 6(a) and FIG. 6(b) are perspective cutaway views of a rear slide connecting part before and after assembling in accordance with the first embodiment of the present invention.

FIG. 7(a) and FIG. 7(b) are perspective cutaway views of a locking protrusion before and after assembling in accordance with the first embodiment of the present invention.

FIG. 8 is a perspective view showing a stacked state in accordance with second embodiment of the present invention.

FIG. 9(a) and FIG. 9(b) are perspective cutaway views of a protruding piece before and after assembling in accordance with the second embodiment of the present invention.

FIG. 9(c) is a perspective cutaway view of the protruding piece after fastening of a scrivet in accordance with the second embodiment of the present invention.

### MODE FOR CARRYING OUT THE INVENTION

Using embodiments shown in appended figures, specific technical concepts of the present invention will be described below in more detail.

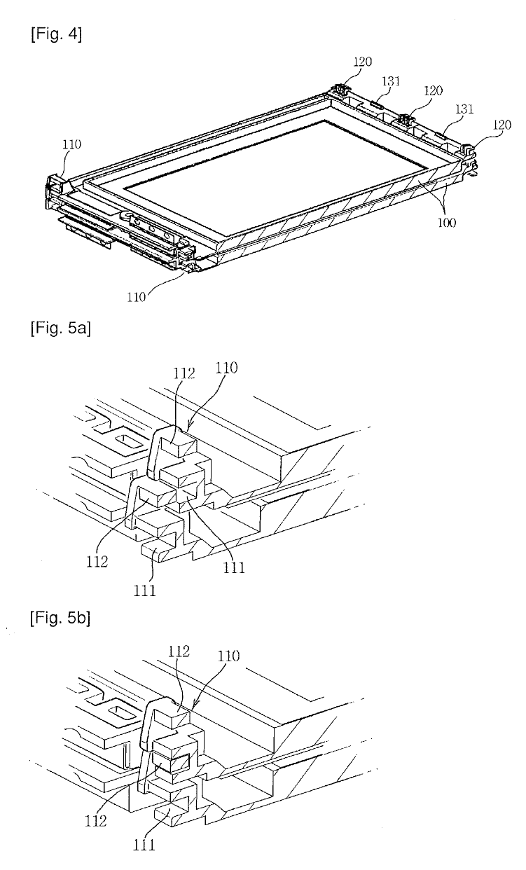

FIG. 3 is a perspective view showing a stacked state in accordance with the first embodiment of the present invention, and FIG. 4 is a perspective cutaway view of a main part in the stacked state in accordance with the first embodiment of the present invention.

As shown in FIG. 3 and FIG. 4 of the first embodiment, a battery case 100 of the present invention is provided with a plurality of slide connecting parts 110 in the front thereof and a plurality of slide connecting parts 120 in the rear thereof such that the battery case 100 can be connected or disconnected through forward-backward sliding movement.

In the battery case 10 of the present invention, each of the front slide connecting parts 110 is configured so as to have an engaged groove 111 formed in its lower part and an engaging piece 112 protrudingly formed in its upper part.

Each of the rear slide connecting parts 120 is configured so as to have an engaged groove 121 formed in its lower part, an engaging protruding piece 122 protrudingly formed in its upper part and an insertion hole 123 in its lower surface, into which the engaging protruding piece 122 can be inserted.

In the first embodiment shown in FIG. 3 and FIG. 4, the two front slide connecting parts 110 are provided in both ends of the front, and the three rear slide connecting parts 120 are provided in both ends and the center of the rear.

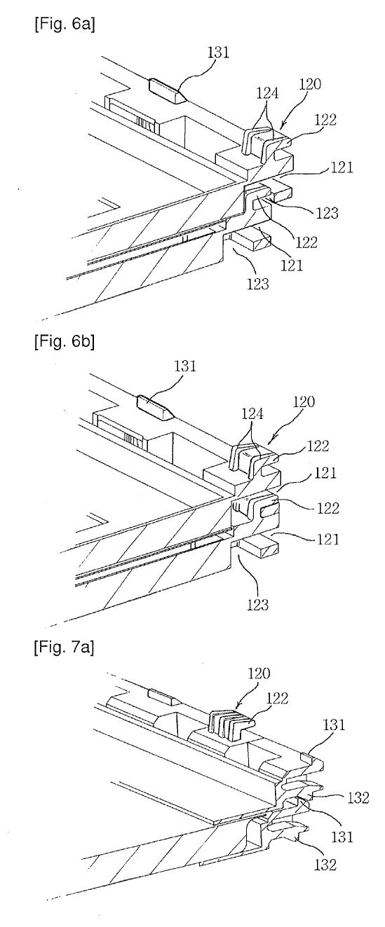

FIG. 5(a) and FIG. 5(b) are perspective cutaway views of the front slide connecting part before and after assembling in accordance with the first embodiment of the present invention, and FIG. 6(a) and FIG. 6(b) are perspective cutaway views of the rear slide connecting part before and after assembling in accordance with the first embodiment of the present invention.

By placing a new battery case 100 to be stacked on the initial battery case 100 of the present invention and pushing the new battery case 100 forward, the two battery cases can be easily connected to each other. As shown in FIG. 5(a), the engaged groove 111 of each upper front slide connecting part 110 of the upper second battery case 100 to be stacked is located in the rear of the engaging piece 112 of each front slide connecting part 110 of the lower first battery case 100. At the same time, as shown in FIG. 6(a), the engaging protruding piece 122 of each rear slide connecting part 120 of the first battery case 100 is inserted into the insertion hole 123 formed on the lower surface of each rear slide connecting part 120 of the second battery case 100, and then the second battery case 100 is pushed forward. Just then, as shown in FIG. 5(b) and FIG. 6(b), the engaging piece 112 of each front slide connecting part 110 of the first battery case 100 is inserted into the engaged groove 111 of each front slide connecting part 110 of the second battery case 100, and the engaging protruding piece 122 of each rear slide connecting part 120 of the first battery case 100 is inserted into the engaged groove 121 of each rear slide connecting part 120 of the second battery case 100, resulting in that the second battery case 100 is correctly assembled onto the first battery case 100.

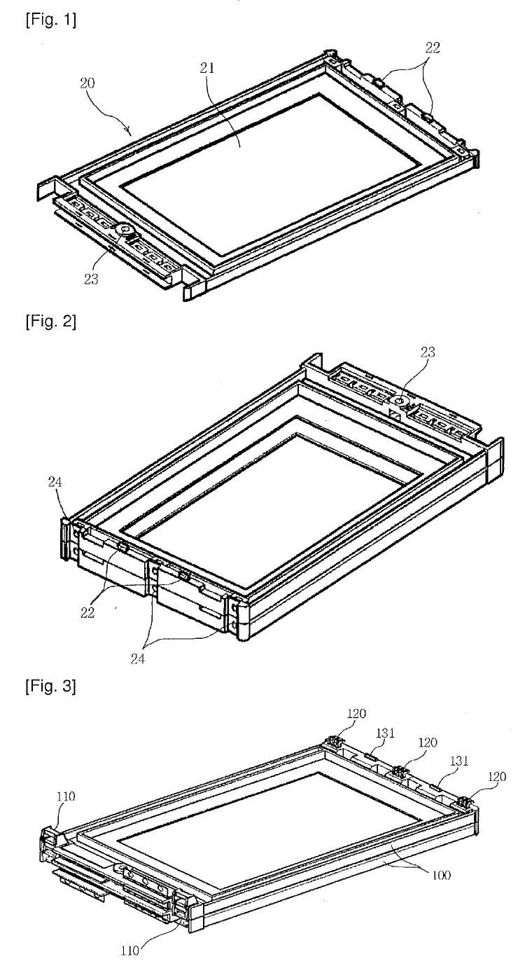

In the first embodiment shown in FIG. 1 to FIG. 6(b), a contact inclined rib 124 is formed on an upper end of the engaging protruding piece 122 of each rear slide connecting parts 120. As a result, when the engaging protruding piece 122 of each rear slide connecting parts 120 of the first battery case 100 is inserted into the engaged groove 121 of each rear slide connecting parts 120 of the second battery case 100, the contact inclined rib 124 is solidly in close contact with an upper inner end surface of the engaged groove 121, thereby preventing vertical movement of the second battery case 100.

The battery case 100 in accordance with the first embodiment of the present invention further includes upper locking protrusions 131 protrudingly formed on both sides of the center of the rear of the upper surface, the upper locking protrusions 131 each having an inclined rear end, and lower locking protrusions 132 depressed on both sides of the center of the rear of the lower surface, the lower locking protrusions 132 each corresponding to the upper locking protrusion 131 and having an inclined front end.

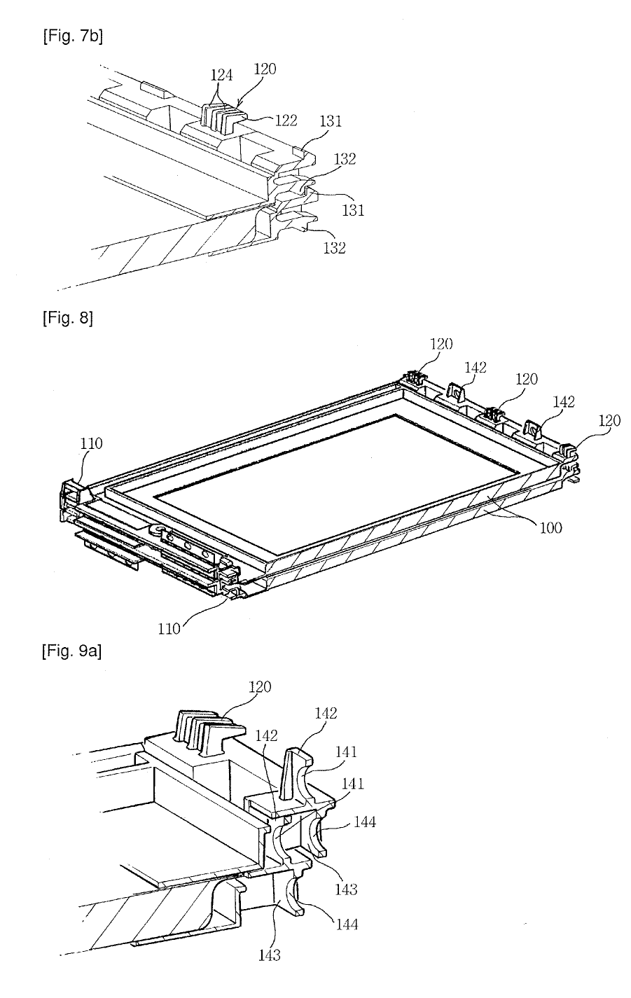

FIG. 7(a) and FIG. 7(b) are perspective cutaway views of the locking protrusion before and after assembling in accordance with the first embodiment of the present invention.

In the first embodiment, as shown in FIG. 7(a), the upper locking protrusions 131 of the first battery case 100 are located in front of the lower locking protrusions 132 of the second battery case 100 and then the second battery case 100 is pushed forward. Just then, as shown in FIG. 7(b), the upper locking protrusions 131 of the first battery case 100 and the lower locking protrusions 132 of the second battery case 100 are engaged with each other; therefore, the second battery case 100 correctly assembled onto the first battery case 100 is prevented from moving in the forward-backward direction.

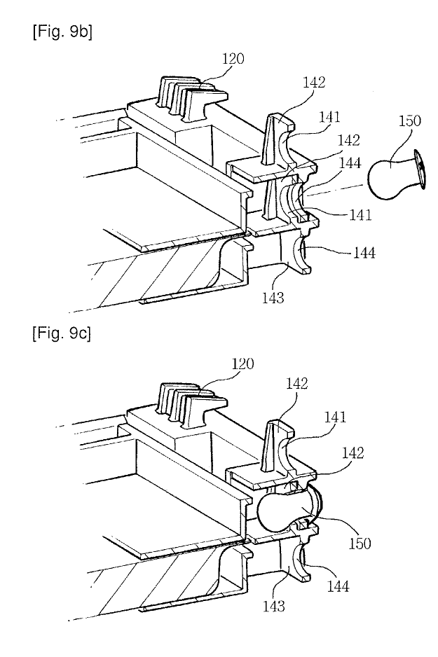

FIG. 8 is a perspective view showing a stacked state in accordance with the second embodiment of the present invention, and FIG. 9(a) and FIG. 9(b) are perspective cutaway views of a protruding piece before and after assembling in accordance with the second embodiment of the present invention, and FIG. 9(c) is a perspective cutaway view of the protruding piece after fastening of a scrivet in accordance with the second embodiment of the present invention.

In the second embodiment of the present invention as shown in FIG. 8 to FIG. 9(c), protruding pieces 142 each having a scrivet connection hole 141 are formed on both sides of the center of the rear of the upper surface, protruding piece insertion spaces 143 are formed on both sides of the center of the rear of the lower surface, and scrivet connection holes 144 are formed in the rear of the protruding piece insertion spaces 143.

In the second embodiment, as shown in FIG. 9(a), the protruding pieces 142 of the first battery case 100 are inserted into the respective protruding piece insertion spaces 143 of the second battery case 100, and then, the second battery case 100 is pushed forward. Just then, as shown in FIG. 9b, the scrivet connection holes 141 formed in the respective protruding pieces 142 of the first battery case 100 and the scrivet connection holes 144 provided in the respective protruding piece insertion spaces 143 of the second battery case 100 are in close contact with each other. A scrivet 150 is fastened from the rear of the protruding piece insertion spaces 143 so as to sequentially penetrate through both the scrivet connection holes 144, 141, thereby preventing the second battery case 100 correctly assembled onto the first battery case 100 from moving in the forward-backward direction.

As described above, the battery case 100 of the present invention can be easily assembled by placing the battery case 100 on the lower battery case 100 and sliding the battery case 100 in the forward-backward direction. The battery case is not disengaged even during assembling.

The assembled upper battery case and lower battery case can be solidly fixed to each other with one-touch action by use of the plastic scrivet 150, and in replacing a faulty battery case, only the faulty battery case can be removed.

It is apparent to those skilled in the art to which the present invention belongs that the above-mentioned present invention is not limited to above description and can be replaced, modified, and changed so as not to deviate from the technical concepts of the present invention.

What is claimed is:

1. A battery case comprising:
a plurality of front slide connection parts each having an engaged groove in a lower part thereof and an engaging piece protrudingly formed in an upper part thereof; and
a plurality of rear slide connection parts each having an engaged groove in a lower part thereof, an engaging protruding piece protrudingly formed in an upper part thereof, and an insertion hole formed in a lower surface thereof into which the engaging protruding piece is inserted,
wherein the battery case is connected or disconnected through a forward-backward sliding movement.

2. A battery case according to claim 1, wherein an upper locking protrusion having an inclined rear end is protrudingly formed in a rear of an upper surface, and
a lower locking protrusion corresponding to the upper locking protrusion and having an inclined front end is formed to be depressed in a rear of the lower surface.

3. A battery case according to claim 1, wherein a protruding piece having a scrivet connection hole is formed in a rear of an upper surface,
a protruding piece insertion space is formed in a rear of a lower surface, and
a scrivet connection hole is formed in a rear of the protruding piece insertion space.
